(19) United States
(12) Patent Application Publication
(10) Pub. No.: US 2010/0244617 A1
(43) Pub. Date: Sep. 30, 2010

(54) STATOR HAVING IMPROVED STRUCTURE FOR RESTRICTING RELATIVE DISPLACEMENT BETWEEN STATOR CORE AND STATOR COIL

(75) Inventors: Kazuhiro Nobata, Chiryu-shi (JP); Masaomi Dobashi, Kariya-shi (JP); Seiji Tachibana, Toyoake-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/749,807

(22) Filed: Mar. 30, 2010

(30) Foreign Application Priority Data
Mar. 30, 2009 (JP) 2009-082442

(51) Int. Cl. H02K 3/48

(52) U.S. Cl. 310/216.069

(57) ABSTRACT

A stator for an electric rotating machine includes a hollow cylindrical stator core and a stator coil made up of a plurality of electric wires mounted on the stator core. The stator core has a plurality of slots that are formed in a radially inner surface of the stator core and spaced at predetermined intervals in the circumferential direction of the stator core. The stator core also has a plurality of tooth portions each of which is formed to radially extend between one circumferentially-adjacent pair of the slots. Moreover, the stator core further has a plurality of displacement restricting portions each of which is formed, as an integral part of the stator core, on an axial end face of a corresponding one of the tooth portions of the stator core to restrict displacement of the stator coil relative to the stator core.

### CROSS-REFERENCE TO RELATED APPLICATION

This application is based on and claims priority from Japanese Patent Application No. 2009-82442, filed on Mar. 30, 2009, the content of which is hereby incorporated by reference in its entirety into this application.

### BACKGROUND OF THE INVENTION

1. Technical Field of the Invention

The present invention relates generally to stators for electric rotating machines that are used in, for example, motor vehicles as electric motors and electric generators. More particularly, the invention relates to a stator for an electric rotating machine which has an improved structure for restricting relative displacement between a stator core and a stator coil of the stator.

2 Description of the Related Art

In recent years, electric rotating machines, such as electric motors and electric generators, have been required to be compact, be able to output high power, and have high quality.

In particular, for electric rotating machines for use in motor vehicles, the spaces available for installation of those machines in the motor vehicles have been decreasing, while the need for them to output high power has been increasing. Moreover, it has also been required to improve the reliability of those electric rotating machines.

Japanese Unexamined Patent Application Publication No. 2000-166158 discloses a winding method for reducing stresses on insulating paper sheets interposed between a stator coil and a stator core of a stator for an electric rotating machine. More specifically, according to the winding method, spacers are first mounted on the axial end faces of the stator core which has the insulating paper sheets arranged in slots thereof. Then, the stator coil is wound around the stator core so that the insulating paper sheets are interposed between the stator core and the stator coil and the spacers are interposed between the axial end faces of the stator core and the stator coil. Thereafter, the spacers are removed from the stator core and the stator coil which together constitute the stator for the electric rotating machine. Consequently, with the use of the spacers, it is possible to reduce stresses which are imposed on the insulating paper sheets during the winding of the stator coil, thereby ensuring the insulation properties of the insulating paper sheets and improving the reliability of the electric rotating machine.

Japanese Unexamined Patent Application Publication No. 2006-33918 discloses a stator for an electric rotating machine which includes field-relaxing blocks. More specifically, the field-relaxing blocks are made of a metal or resin and have a circular or triangular cross-section. The field-relaxing members are mounted on the axial end faces of teeth of a stator core of the stator, thereby preventing electric field from concentrating on the axial end of the stator core.

FIG. 15 shows a conventional stator 3A for an electric rotating machine. The stator 3A includes a stator core 30A, a stator coil 40A, and a plurality of spacers 50A. The stator core 30A is composed of a plurality of stator core segments 300A that are arranged in the circumferential direction of the stator core 30A to adjoin one another. The stator coil 40A is wound around the stator core 30A. The spacers 50A are substantially U-shaped. Each of the spacers 50A is interposed between an axial end face of the stator core 30A and the stator coil 40A in the axial direction of the stator core 30A and has two leg portions 51A that interpose a pair of adjoining surfaces 33A of the stator core segments 300A in the circumferential direction of the stator core 30A.

With the spacers 50A, it is possible to restrict displacement of the stator coil 40A relative to the stator core 30A.

However, with the separate formation of the spacers 50A from the stator core 30A, it is necessary to manufacture and assemble the same number of the spacers 50A as the pairs of the adjoining surfaces 33A of the stator core segments 300A. As a result, the parts count and thus the assembling cost of the stator 3A is increased.

Moreover, in the conventional stator 3A, the spacers 50A are fixed to neither the stator core 30A nor the stator coil 40A. Consequently, the spacers 50A may be displaced from the initial positions thereof or even be detached from the stator 3A due to vibrations and/or thermal and mechanical stresses imposed thereon during operation of the electrical rotating machine. Further, when the spacers 50A are detached from the stator 3A, the stator core 30A and the stator coil 40A may make contact with each other, thereby damaging the stator coil 40A. As a result, the insulation properties of the stator coil 40A would be degraded, thereby lowering the reliability of the electric rotating machine.

### SUMMARY OF THE INVENTION

According to one aspect of the present invention, there is provided a stator for an electric rotating machine. The stator includes a hollow cylindrical stator core and a stator coil. The stator core has a plurality of slots that are formed in a radially inner surface of the stator core and spaced at predetermined intervals in a circumferential direction of the stator core. The stator core also has a plurality of tooth portions each of which is formed to radially extend between one circumferentially-adjacent pair of the slots. The stator coil is made up of a plurality of electric wires mounted on the stator core. Each of the electric wires has a plurality of in-slot portions, each of which is received in one of the slots of the stator core, and a plurality of turn portions each of which is located outside of the slots of the stator core to connect one adjacent pair of the in-slot portions of the electric wire. Furthermore, the stator core has a plurality of displacement restricting portions each of which is formed, as an integral part of the stator core, on an axial end face of a corresponding one of the tooth portions of the stator core to restrict displacement of the stator coil relative to the stator core.

With the integral formation of the displacement restricting portions with the stator core, the displacement restricting portions can be reliably prevented from being detached from the stator due to vibrations and/or thermal and mechanical stresses imposed thereon during operation of the electric rotating machine. Accordingly, with the displacement restricting portions, the stator coil can be reliably prevented from making contact with the stator core and thereby being damaged during operation of the electric rotating machine. As a result, the insulation properties of the stator coil can be ensured, thereby ensuring high reliability of the electric rotating machine.

Moreover, with the integral formation of the displacement restricting portions with the stator core, the parts count and thus the assembling cost of the stator can be reduced.

In further implementations of the present invention, the stator core may be made up of a plurality of stator core pieces that are laminated in the axial direction of the stator core. The displacement restricting portions of the stator core may be preferably formed only in axially-outmost ones of the stator core pieces. Further, all of the stator core pieces may be preferably made of the same metal and each in the form of a metal sheet. The thickness of the axially-outmost stator core pieces in the axial direction of the stator core may be preferably set to be greater than the thickness of the other stator core pieces.

Each of the displacement restricting portions may be formed as a protrusion that protrudes from the axial end face of the corresponding tooth portion of the stator core and radially extends along the corresponding tooth portion. Further, the stator core may be made up of a plurality of metal sheets that are laminated in the axial direction of the stator core. Each of the protrusions may be preferably formed only in an axially-outmost one of the metal sheets with its circumferential ends connected to the axially-outmost metal sheet and its radial ends separated from the axially-outmost metal sheet. Alternatively, each of the protrusions may be preferably formed only in an axially-outmost one of the metal sheets with its radial ends connected to the axially-outmost metal sheet and its circumferential ends separated from the axially-outmost metal sheet. Furthermore, each of the protrusions may be preferably formed only in the axially-outmost metal sheet by pressing. Alternatively, each of the protrusions may be preferably formed only in the axially-outmost metal sheet by cutting and raising.

Otherwise, each of the displacement restricting portions may be formed as a tab that protrudes from the axial end face of the corresponding tooth portion of the stator core and radially extends along the corresponding tooth portion with only a radial end thereof connected to the corresponding tooth portion. Further, the stator core may be made up of a plurality of metal sheets that are laminated in the axial direction of the stator core. Each of the tabs may be preferably formed only in an axially-outmost one of the metal sheets with only the radial end thereof connected to the axially-outmost metal sheet. Moreover, each of the tabs may be preferably formed only in the axially-outmost metal sheet by cutting and raising.

The stator core may be composed of a plurality of stator core segments that are arranged in the circumferential direction of the stator core to adjoin one another.

According to another aspect of the present invention, there is provided an electric rotating machine which includes a rotating shaft, a rotor fixed on the rotating shaft, and a stator surrounding the rotor. The stator includes a hollow cylindrical stator core and a stator coil. The stator core has a plurality of slots that are formed in a radially inner surface of the stator core and spaced at predetermined intervals in a circumferential direction of the stator core. The stator core also has a plurality of tooth portions each of which is formed to radially extend between one circumferentially-adjacent pair of the slots. The stator coil is made up of a plurality of electric wires mounted on the stator core. Each of the electric wires has a plurality of in-slot portions, each of which is received in one of the slots of the stator core, and a plurality of turn portions each of which is located outside of the slots of the stator core to connect one adjacent pair of the in-slot portions of the electric wire. Furthermore, the stator core has a plurality of displacement restricting portions each of which is formed, as an integral part of the stator core, on an axial end face of a corresponding one of the tooth portions of the stator core to restrict displacement of the stator coil relative to the stator core.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a schematic cross-sectional view illustrating the overall configuration of an electric rotating machine which includes a stator according to the first embodiment of the invention;

FIG. 2 is a schematic end view of the stator;

FIG. 3 is a schematic end view of a stator core of the stator;

FIG. 4 is a schematic perspective view illustrating the structure of the stator core;

FIG. 5 is a schematic perspective view illustrating the configuration of displacement restricting portions of the stator core for restricting relative displacement between the stator core and the stator coil according to the first embodiment;

FIG. 6A is a cross-sectional view taken along the line I-I in FIG. 5;

FIG. 6B is a cross-sectional view taken along the line II-II in FIG. 5;

FIG. 7A is a schematic cross-sectional view illustrating the configuration of electric wires forming a stator coil of the stator;

FIG. 7B is a schematic cross-sectional view illustrating a modification of the configuration of the electric wires shown in FIG. 7A;

FIG. 8 is a schematic circuit diagram of the stator;

FIG. 9 is a plan view of an electric wire assembly for forming the stator coil;

FIG. 10 is a front view of the stator coil that is obtained by rolling the electric wire assembly;

FIG. 11 is a schematic perspective view illustrating the configuration of displacement restricting portions of the stator core according to the second embodiment of the invention;

FIG. 12A is a cross-sectional view taken along the line III-III in FIG. 11;

FIG. 12B is a cross-sectional view taken along the line IV-IV in FIG. 11;

FIG. 13 is a schematic perspective view illustrating the configuration of displacement restricting portions of the stator core according to the third embodiment of the invention;

FIG. 14A is a cross-sectional view taken along the line V-V in FIG. 13;

FIG. 14B is a cross-sectional view taken along the line VI-VI in FIG. 13; and

FIG. 15 is a schematic view illustrating the use of spacers in a conventional stator for an electric rotating machine.

### DESCRIPTION OF PREFERRED EMBODIMENTS

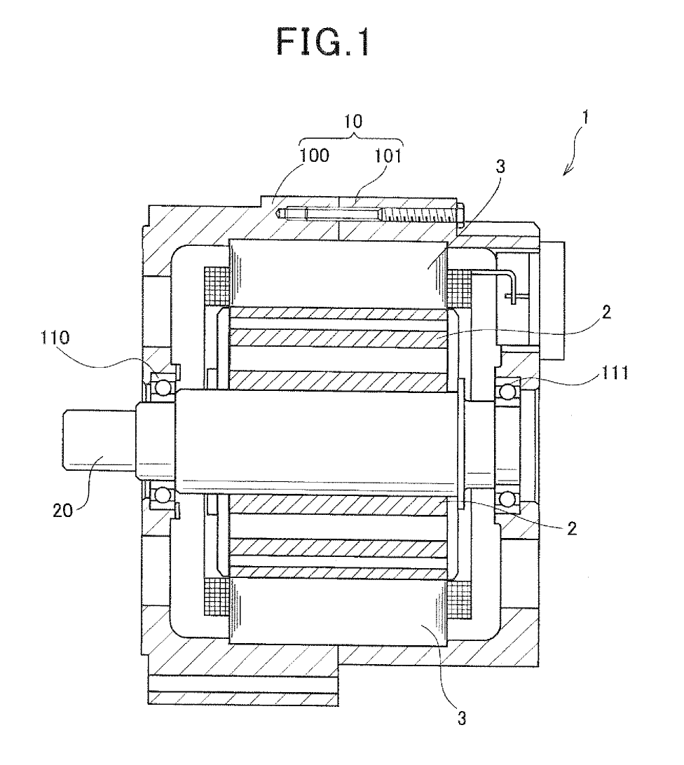

Preferred embodiments of the present invention will be described hereinafter with reference to FIGS. 1-14.

It should be noted that, for the sake of clarity and understanding, identical components having identical functions in different embodiments of the invention have been marked, where possible, with the same reference numerals in each of the figures.

### First Embodiment

FIG. 1 shows the overall configuration of an electric rotating machine 1 which includes a stator 3 according to the first embodiment of the invention.

The electric rotating machine 1 is for use in a motor vehicle, such as en electric vehicle or a hybrid vehicle, and can function both as an electric motor and as an electric generator.

As shown in FIG. 1, the electric rotating machine 1 further includes a housing 10 and a rotor 2 in addition to the stator 3. The housing 10 is composed of a pair of cup-shaped housing pieces 100 and 101 which are jointed together at the open ends thereof. The housing 10 has a pair of bearings 110 and 111 mounted therein, via which a rotating shaft 20 is rotatably supported by the housing 10. The rotor 2 is received in the housing 10 and fixed on the rotating shaft 20. The stator 3 is fixed in the housing 10 so as to surround the radially outer periphery of the rotor 2.

The rotor 2 includes a plurality of permanent magnets that form a plurality of magnetic poles on a radially outer periphery of the rotor 2 to face a radially inner periphery of the stator 3. The polarities of the magnetic poles alternate between north and south in the circumferential direction of the rotor 2. The number of the magnetic poles is set according to the design specification of the electric rotating machine 1. In the present embodiment, the number of the magnetic poles is set to be equal to, for example, eight (i.e., four north poles and four south poles).

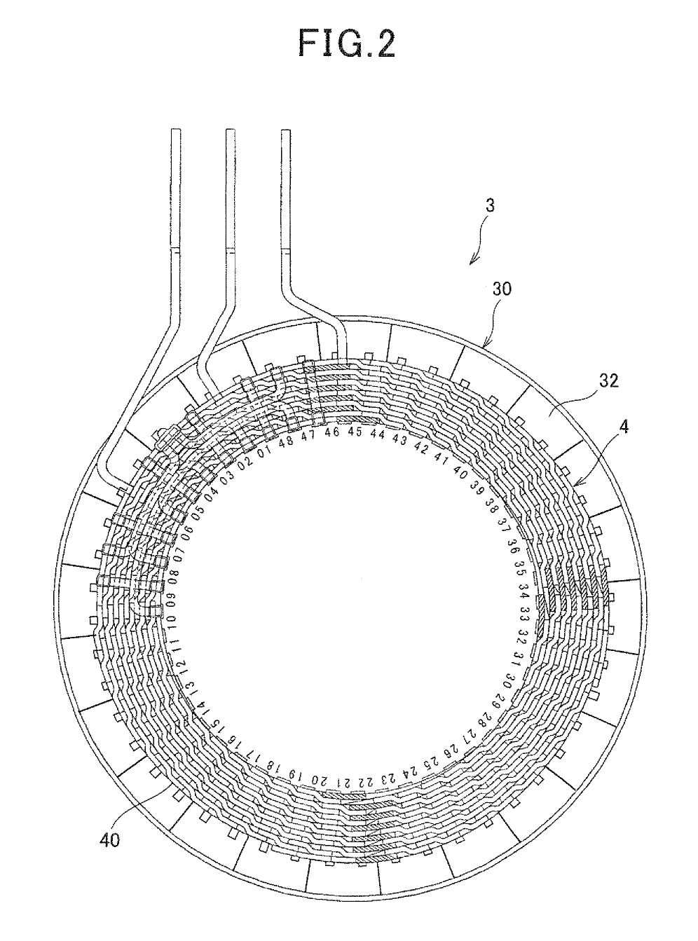

Referring now to FIG. 2, the stator 3 includes a hollow cylindrical stator core 30 and a three-phase stator coil 4 mounted on the stator core 30. In addition, the stator 3 may further have insulating paper sheets interposed between the stator core 30 and the stator coil 4.

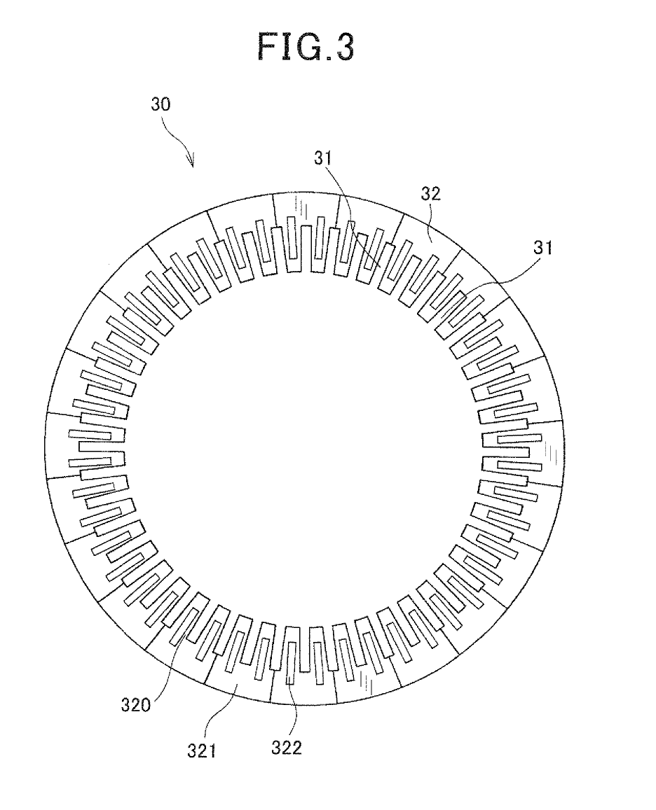

The stator core 30 has, as shown in FIG. 3, a plurality of slots 31 that are formed in the radially inner surface of the stator core 30 and spaced in the circumferential direction of the stator core 30 at predetermined intervals. For each of the slots 31, the depth-wise direction of the slot 31 is coincident with the radial direction of the stator core 30. In the present embodiment, with respect to each of the eight magnetic poles of the rotor 2, there are provided two slots 31 for each of the three phases of the stator coil 4. Accordingly, the total number of the slots 31 provided in the stator core 30 is equal to 48 (i.e., 8×3×2). In addition, in FIG. 2, slot numbers 1-48 are respectively given to the 48 slots 31, at the same circumferential positions as the respective slots 31, so as to distinguish the slots 31 from one another.

The stator core 30 also has a plurality of tooth portions 320, each of which radially extends between a pair of circumferentially-adjacent slots 31, and a back core portion 321 that is located radially outward of the tooth portions 320 to connect them.

Moreover, in the present embodiment, the stator core 30 is made up of, for example, 24 stator core segments 32 that are arranged in the circumferential direction of the stator core 30 to adjoin one another. Each of the stator core segments 32 defines therein one of the slots 31 of the stator core 30. Further, each circumferentially-adjoining pair of the stator core segments 32 together defines one of the slots 31 therebetween. Furthermore, each of the stator core segments 32 defines therein two of the tooth portions 320 of the stator core 30.

In addition, in the present embodiment, each of the stator core segments 32 is formed by laminating a plurality of (e.g., 410) magnetic steel sheets 32A with a plurality of insulting films interposed therebetween. Each of the magnetic steel sheets 32A has a thickness of, for example, 0.3 mm. It should be noted that other conventional metal sheets may also be used instead of the magnetic steel sheets 32A.

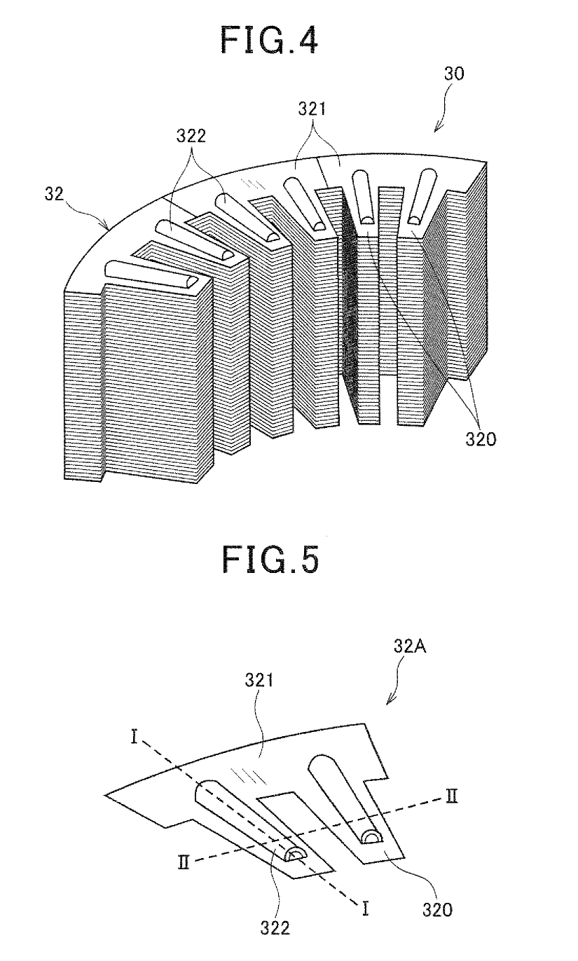

Referring to FIGS. 3 and 4, in the present embodiment, the stator core 30 has a plurality of protrusions 322 each of which is formed as an integral part of the stator core 30 to protrude from an axial end face of a corresponding one of the tooth portions 320 and radially extends along the corresponding tooth portion 320.

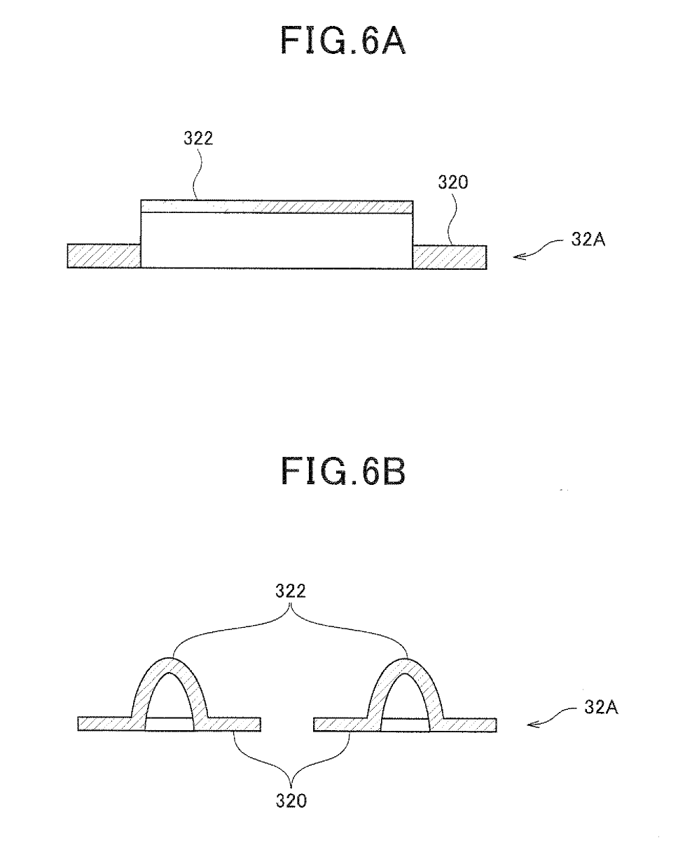

FIG. 5 shows an axially-outmost one of the magnetic steel sheets 32A that form the stator core 30. FIGS. 6A and 6B are cross-sectional views respectively taken along the lines I-I and II-II in FIG. 5.

As shown in FIGS. 5 and 6A-6B, in the present embodiment, each of the protrusions 322 of the stator core 30 is formed by pressing an axially-outmost one of the magnetic steel sheets 32A to have a substantially U-shaped cross-section perpendicular to the radial direction of the stator core 30 (or to the line I-I in FIG. 5). Each of the protrusions 322 has its circumferential ends (i.e., ends in the circumferential direction of the stator core 30) connected to the axially-outmost magnetic steel sheet 32A and its radial ends (i.e., ends in the radial direction of the stator core 30) separated from the axially-outmost magnetic steel sheet 32A.

The three-phase stator coil 4 is composed of a plurality of (e.g., twelve in the present embodiment) wave-shaped electric wires 40 wound around the stator core 30.

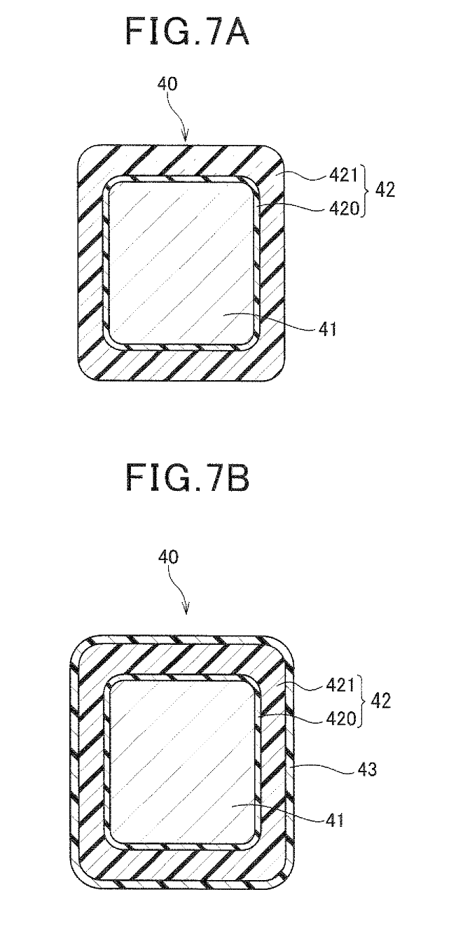

Each of the electric wires 40 is configured with, as shown in FIG. 7A, an electric conductor 41 and an insulating coat 42 that covers the outer surface of the electric conductor 41. In the present embodiment, the electric conductor 41 is made of copper and has a rectangular cross section. With the rectangular cross section, it is possible to mount the electric wires 40 on the stator core 30 at high density. Moreover, in the present embodiment, the insulating coat 42 is two-layer structured to include an inner layer 420 and an outer layer 421. The thickness of the insulating coat 42 (i.e., the sum of thicknesses of the inner and outer layers 420 and 421) is set to be in the range of 100 to 200 μm.

With such a large thickness of the two-layer structured insulating coat 42, it is possible to reliably insulate the electric wires 40 from one another without interposing insulating paper sheets therebetween. However, it is also possible to interpose insulating paper sheets between the electric wires 40 so as to further enhance the electrical insulation therebetween.

Further, the outer layer 421 is made of an insulating material such as nylon. The inner layer 420 is made of an insulating material having a higher glass transition temperature than the outer layer 421, such as a thermoplastic resin or a polyamide-imide resin. Consequently, the outer layers 421 of the electric wires 40 will be softened by the heat generated by operation of the electric rotating machine 1 earlier than the inner layers 420, thereby bonding together those portions of the electric wires 40 which are received in the same ones of the slots 31 of the stator core 30. As a result, those portions of the electric wires 40 will be integrated into a rigid body, thereby enhancing the mechanical strength thereof. In addition, for each of the electric wires 40, when excessive vibration occurs, the outer layer 421 will be first separated from the inner layer 420, leaving the inner layer 420 to keep covering the outer surface of the electric conductor 41. As a result, the electrical insulation between the electric wires 40 can be maintained.

Furthermore, as shown in FIG. 7B, it is also possible for each of the electric wires 40 to further include a fusible coat 43 to cover the outer surface of the insulating coat 42. The fusible coat 43 may be made, for example, of epoxy resin. In this case, the fusible coats 43 of the electric wires 40 will be fused by the heat generated by operation of the electric rotating machine 1 earlier than the insulating coats 42, thereby bonding together those portions of the electric wires 40 which are received in the same ones of the slots 31 of the stator core 30. As a result, those portions of the electric wires 40 will be integrated into a rigid body, thereby enhancing the mechanical strength thereof. In addition, in this case, the outer layers 421 of the insulating coats 42 of the electric wires 40 may also be made of PPS (polyphenylene sulfide).

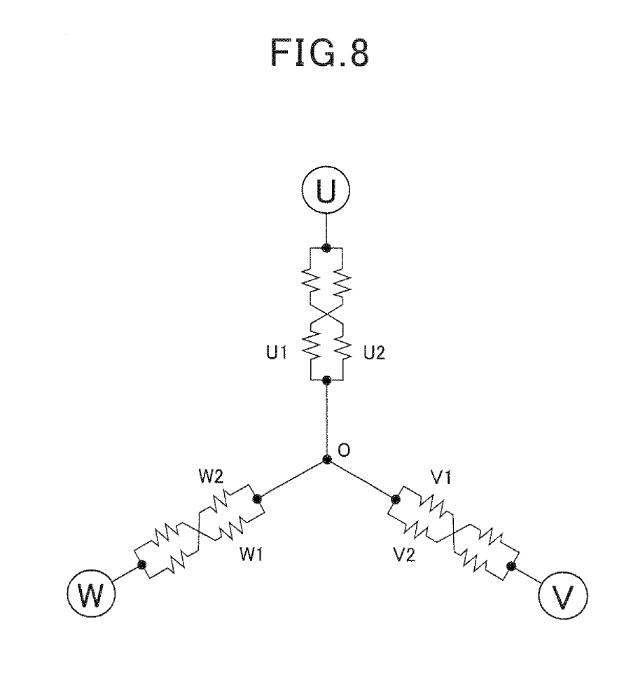

Referring to FIG. 8, in the present embodiment, the stator coil 4 includes six phase windings U1, U2, V1, V2, W1, and W2. The phase windings U1 and U2 are connected in parallel with each other to make up a U-phase winding of the stator coil 4. Similarly, the phase windings V1 and V2 are connected in parallel with each other to make up a V-phase winding of the stator coil 4. The phase windings W1 and W2 are connected in parallel with each other to make up a W-phase winding of the stator coil 4. Further, the U-phase, V-phase, and W-phase windings are Y-connected to have a neutral point O therebetween.

Moreover, in the present embodiment, each of the six phase windings U1, U2, V1, V2, W1, and W2 of the stator coil 4 is formed by joining a pair of the electric wires 40 by, for example, welding. In other words, each of the six phase windings U1, U2, V1, V2, W1, and W2 is composed of two of the twelve electric wires 40.

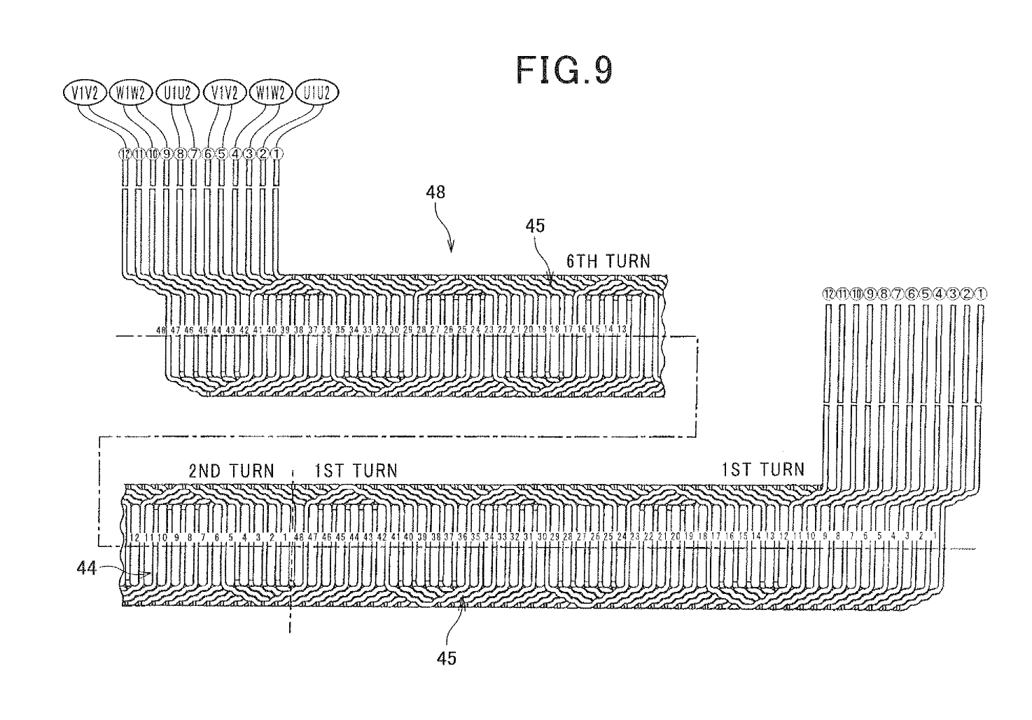

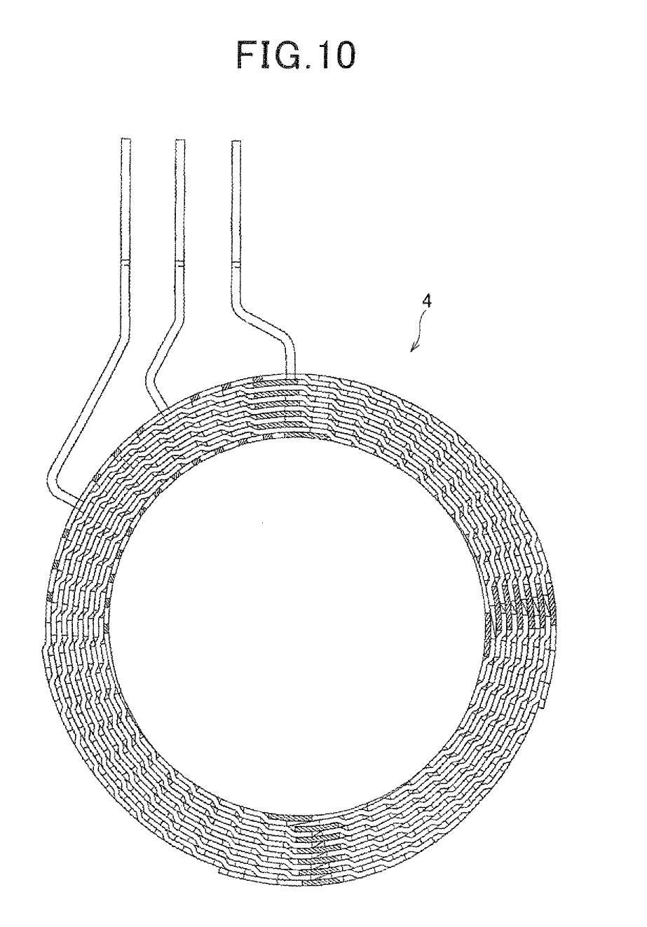

In the present embodiment, the stator coil 4 is manufactured by stacking the twelve wave-shaped electric wires 40 to form a flat band-shaped electric wire assembly 46 as shown in FIG. 9 and rolling the flat band-shaped electric wire assembly 46 by a predetermined number of turns (e.g., six turns) into a hollow cylindrical shape as shown in FIG. 10. In addition, in FIG. 9, the twelve wave-shaped electric wires 40 are numbered with circled numbers 1-12.

Referring to FIG. 9, each of the twelve electric wires 40 is wave-shaped to include a plurality of in-slot portions 44 and a plurality of turn portions 45.

The in-slot portions 44 are equally spaced in the longitudinal direction of the electric wire 40 and extend perpendicular to the longitudinal direction. After assembling the stator core 30 to the stator coil 4, each of the in-slot portions 44 is received in a corresponding one of the slots 31 of the stator core 30.

Each of the turn portions 45 extends, on one side of the in-slot portions 44, with a turn to connect one adjacent-pair of the in-slot portions 44. After assembling the stator core 30 to the stator coil 4, each of the turn portions 45 is located outside of the slots 31 of the stator core 30.

In the stator 3, each of the twelve electric wires 40 is wave-wound around the stator core 30 so as to extend in the circumferential direction of the stator core 30. In the present embodiment, the slots 31 of the stator core 30 are divided into eight groups each of which includes six circumferentially-adjacent slots 31. For each of the electric wires 40, all of the in-slot portions 44 of the electric wire 40 are received in eight slots 31 that belong respectively to the eight groups and are spaced six slots 31 apart in the circumferential direction of the stator core 30. Further, for each of the electric wires 40, each of the turn portions 45 of the electric wire 40 protrudes from one of the axial end faces of the stator core 30 to connect one circumferentially-adjacent pair of the in-slot portions 44 of the electric wire 40. Consequently, all of the turn portions 45 of the electric wires 40 are located outside of the slots 31 of the stator core 30 to make up coil ends of the stator coil 4.

After having described the structure of the stator 3 according to the present embodiment, advantages thereof will be described hereinafter.

In the present embodiment, the stator core 30 has the protrusions 322 that are interposed between the axial end faces of the tooth portions 322 of the stator core 30 and the turn portions 45 of the electric wires 40 forming the stator coil 4. The protrusions 322 function as displacement restricting portions of the stator core 30 to restrict displacement of the stator coil 4 relative to the stator core 30. Further, each of the protrusions 322 is formed as an integral part of the stator core 30.

Consequently, with the integral formation of the protrusions 322 with the stator core 30, the protrusions 322 can be reliably prevented from being detached from the stator 3 due to vibrations and/or thermal and mechanical stresses imposed thereon during operation of the electric rotating machine 1. Accordingly, with the protrusions 322, the stator coil 4 can be reliably prevented from making contact with the stator core 30 and thereby being damaged during operation of the electric rotating machine 1. As a result, the insulation properties of the stator coil 4 can be ensured, thereby ensuring high reliability of the electric rotating machine 1.

Moreover, with the integral formation of the protrusions 322 with the stator core 30, the parts count and thus the assembling cost of the stator 3 can be reduced.

Furthermore, though not shown in the figures, the electric rotating machine 1 further includes a coolant supplying device that supplies a coolant (e.g., ATF) to the turn portions 45 of the electric wires 40 forming the stator coil 4. In the present embodiment, the coolant, which has flowed from the turn portions 45 to the axial end faces of the tooth portions 322 of the stator core 30, can further flow radially inward along the protrusions 322, thereby cooling the inside of the turn portions 45. As a result, the cooling performance of the electric rotating machine 1 can be improved.

In the present embodiment, the stator core 30 is composed of the stator core segments 32 that are arranged in the circumferential direction of the stator core 30 to adjoin one another. In this case, with the integral formation of the protrusions 322 with the corresponding stator core segments 32A, the protrusions 322 can be easily handled together with the corresponding stator core segments 322, thereby suppressing the assembling cost of the stator 3.

In the present embodiment, each of the stator core segments 32 is made by laminating the plurality of magnetic steel sheets 32A. Further, for each of the stator core segments 32, the protrusions 322 are formed only in the outmost ones of the magnetic steel sheets 32A of the stator core segment 32.

Consequently, the stator core 30 can be easily formed without making a large modification to an existing stator core that has the same structure as the stator core 30 except for the protrusions 32.

In the present embodiment, each of the protrusions 322 is formed to protrude from the axial end face of the corresponding tooth portion 320 of the stator core 30 and radially extend along the corresponding tooth portion 320.

With the above formation of the protrusions 322, it is possible for the protrusions 322 to restrict displacement of the stator coil 4 relative to the stator core 30 over almost the entire radial width of the stator coil 4.

In the present embodiment, each of the protrusions 322 is formed by pressing an axially-outmost one of the magnetic steel sheets 32A to have a substantially U-shaped cross-section perpendicular to the radial direction of the stator core 30. Each of the protrusions 322 has its circumferential ends connected to the axially-outmost magnetic steel sheet 32A and its radial ends separated from the axially-outmost magnetic steel sheet 32A.

With the above formation of the protrusions 322, it is possible to easily provide the protrusions 322 in the stator core 30 at low cost.

### Second Embodiment

This embodiment illustrates a configuration of the displacement restricting portions of the stator core 30 which is different from that according to the first embodiment.

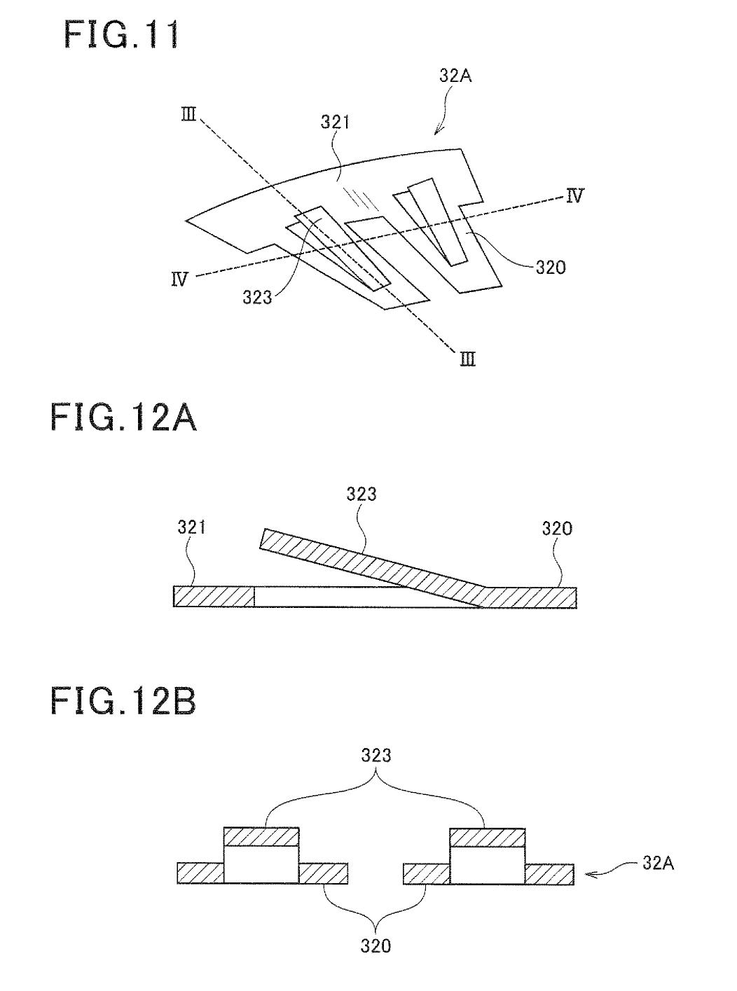

FIG. 11 shows an axially-outmost one of the magnetic steel sheets 32A according to the present embodiment. FIGS. 12A and 12B are cross-sectional views respectively taken along the lines III-III and IV-IV in FIG. 11.

As shown in FIGS. 11 and 12A-12B, in the present embodiment, the stator core 30 has a plurality of tabs 323 instead of the protrusions 322 according to the first embodiment. Each of the tabs 323 is formed as an integral part of the stator core 30 to protrude from an axial end face of a corresponding one of the tooth portions 320 and radially extends along the corresponding tooth portion 320.

More specifically, in the present embodiment, each of the tabs 323 is shaped in a rectangular strip and has only a redial end thereof (i.e., an end thereof in the radial direction of the stator core 30) connected to the axially-outmost metal sheet 32A. Moreover, each of the tabs 323 is formed by first cutting the axially-outmost magnetic steel sheet 32A along three sides of the rectangular strip and then raising the strip to protrude from the axial end face of the axially-outmost magnetic steel sheet 32A.

In the stator 3, the tabs 323 are interposed between the axial end faces of the tooth portions 322 of the stator core 30 and the turn portions 45 of the electric wires 40 forming the stator coil 4. The tabs 322 function as the displacement restricting portions of the stator core 30 to restrict displacement of the stator coil 4 relative to the stator core 30.

### Third Embodiment

This embodiment illustrates a configuration of the displacement restricting portions of the stator core 30 which is different from that according to the first embodiment.

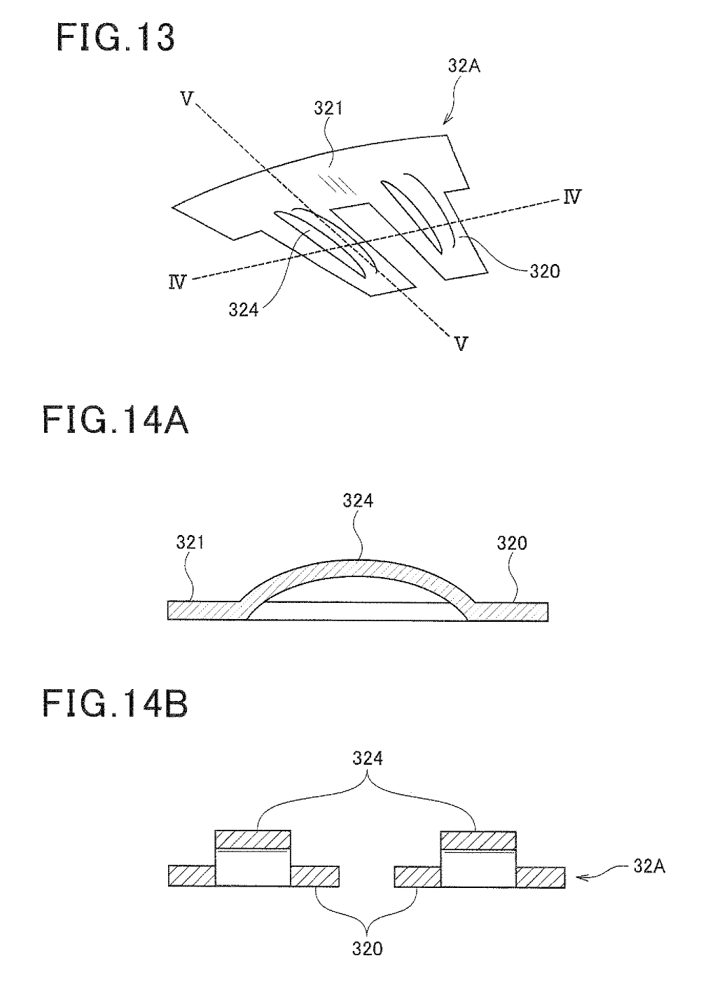

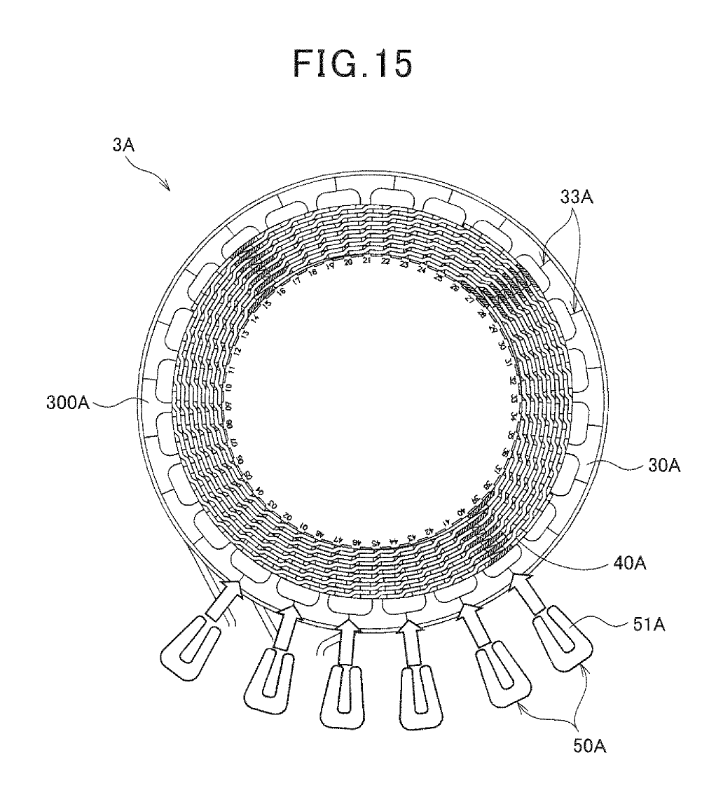

FIG. 13 shows an axially-outmost one of the magnetic steel sheets 32A according to the present embodiment. FIGS. 14A and 14B are cross-sectional views respectively taken along the lines V-V and VI-VI in FIG. 13.

As shown in FIGS. 13 and 14A-14B, in the present embodiment, the stator core 30 has a plurality of protrusions 324 instead of the protrusions 322 according to the first embodiment. Each of the protrusions 324 is formed as an integral part of the stator core 30 to protrude from an axial end face of a corresponding one of the tooth portions 320 and radially extends along the corresponding tooth portion 320.

More specifically, in the present embodiment, each of the protrusions 324 has a substantially U-shaped cross-section parallel to the radial direction of the stator core 30 (or parallel to the V-V line and perpendicular to the VI-VI line in FIG. 13). Each of the protrusions 324 has its radial ends (i.e., ends in the radial direction of the stator core 30) connected to the axially-outmost magnetic steel sheet 32A and its circumferential ends (i.e., ends in the circumferential direction of the stator core 30) separated from the axially-outmost magnetic steel sheet 32A. Moreover, each of the protrusions 324 is formed by first cutting the axially-outmost magnetic steel sheet 32A along two lines that radially extend and are circumferentially spaced and then raising the portion between the two lines to protrude from the axial end face of the axially-outmost magnetic steel sheet 32A.

In the stator 3, the protrusions 324 are interposed between the axial end faces of the tooth portions 322 of the stator core 30 and the turn portions 45 of the electric wires 40 forming the stator coil 4. The protrusions 324 function as the displacement restricting portions of the stator core 30 to restrict displacement of the stator coil 4 relative to the stator core 30.

While the above particular embodiments of the invention have been shown and described, it will be understood by those skilled in the art that various modifications, changes, and improvements may be made without departing from the spirit of the invention.

### Modification 1

In the first embodiment, each of the stator core segments 32 is formed by laminating the plurality of magnetic steel sheets 32A. In other words, for each of the stator core segments 32, all of the sheets (or stator core pieces) forming the stator core segment 32 are made of the same material. However, for each of the stator core segments 32, it is also possible to make the outmost sheets with a different material from the other sheets.

### Modification 2

In the first embodiment, each of the magnetic steel sheets 32A has a thickness of 0.3 mm. In other words, for each of the stator core segments 32, all of the magnetic steel sheets 32A forming the stator core segment 32 have the same thickness.

However, for each of the stator core segments 32, it is also possible to set the thickness of the outmost magnetic steel sheets 32A larger than the thickness of the other magnetic steel sheets 32A. In this case, it is possible to make the protrusions 322 more rigid and more protruding from the axial end faces of the tooth portions 320 of the stator core 30, thereby more reliably restrict displacement of the stator coil 4 relative to the stator core 30.

### Modification 3

In the first embodiment, the protrusions 322 are formed in the axially-outmost magnetic steel sheets 32A by pressing. However, it is also possible to form the protrusions 322 in the axially-outmost magnetic steel sheets 32A by cutting and raising as in the third embodiment.

### Modification 4

In the third embodiment, the protrusions 324 are formed in the axially-outmost magnetic steel sheets 32A by cutting and raising. However, it is also possible to form the protrusions 324 in the axially-outmost magnetic steel sheets 32A by pressing as in the first embodiment.

What is claimed is:

1. A stator for an electric rotating machine, the stator comprising:
a hollow cylindrical stator core having a plurality of slots that are formed in a radially inner surface of the stator core and spaced at predetermined intervals in a circumferential direction of the stator core, the stator core also having a plurality of tooth portions each of which is formed to radially extend between one circumferentially-adjacent pair of the slots; and
a stator coil made up of a plurality of electric wires mounted on the stator core, each of the electric wires having a plurality of in-slot portions, each of which is received in one of the slots of the stator core, and a plurality of turn portions each of which is located outside of the slots of the stator core to connect one adjacent pair of the in-slot portions of the electric wire,
wherein
the stator core has a plurality of displacement restricting portions each of which is formed, as an integral part of the stator core, on an axial end face of a corresponding one of the tooth portions of the stator core to restrict displacement of the stator coil relative to the stator core.

2. The stator as set forth in claim 1, wherein the stator core is made up of a plurality of stator core pieces that are laminated in an axial direction of the stator core, and
the displacement restricting portions of the stator core are formed only in axially-outmost ones of the stator core pieces.

3. The stator as set forth in claim 2, wherein all of the stator core pieces are made of the same metal and each in the form of a metal sheet.

4. The stator as set forth in claim 2, wherein the thickness of the axially-outmost stator core pieces in the axial direction of the stator core is greater than the thickness of the other stator core pieces.

5. The stator as set forth in claim 1, wherein each of the displacement restricting portions is formed as a protrusion that protrudes from the axial end face of the corresponding tooth portion of the stator core and radially extends along the corresponding tooth portion.

6. The stator as set forth in claim 5, wherein the stator core is made up of a plurality of metal sheets that are laminated in an axial direction of the stator core, and
each of the protrusions is formed only in an axially-outmost one of the metal sheets with its circumferential ends connected to the axially-outmost metal sheet and its radial ends separated from the axially-outmost metal sheet.

7. The stator as set forth in claim 5, wherein the stator core is made up of a plurality of metal sheets that are laminated in an axial direction of the stator core, and
each of the protrusions is formed only in an axially-outmost one of the metal sheets with its radial ends connected to the axially-outmost metal sheet and its circumferential ends separated from the axially-outmost metal sheet.

8. The stator as set forth in claim 5, wherein the stator core is made up of a plurality of metal sheets that are laminated in an axial direction of the stator core, and
each of the protrusions is formed only in an axially-outmost one of the metal sheets by pressing.

9. The stator as set forth in claim 5, wherein the stator core is made up of a plurality of metal sheets that are laminated in an axial direction of the stator core, and
each of the protrusions is formed only in an axially-outmost one of the metal sheets by cutting and raising.

10. The stator as set forth in claim 1, wherein each of the displacement restricting portions is formed as a tab that protrudes from the axial end face of the corresponding tooth portion of the stator core and radially extends along the corresponding tooth portion with only a radial end thereof connected to the corresponding tooth portion.

11. The stator as set forth in claim 10, wherein the stator core is made up of a plurality of metal sheets that are laminated in an axial direction of the stator core, and
each of the tabs is formed only in an axially-outmost one of the metal sheets with only the radial end thereof connected to the axially-outmost metal sheet.

12. The stator as set forth in claim 10, wherein the stator core is made up of a plurality of metal sheets that are laminated in an axial direction of the stator core, and
each of the tabs is formed only in an axially-outmost one of the metal sheets by cutting and raising.

13. The stator as set forth in claim 1, wherein the stator core is composed of a plurality of stator core segments that are arranged in the circumferential direction of the stator core to adjoin one another.

14. An electric rotating machine comprising a rotating shaft, a rotor fixed on the rotating shaft, and a stator surrounding the rotor, wherein the stator comprises:
a hollow cylindrical stator core having a plurality of slots that are formed in a radially inner surface of the stator core and spaced at predetermined intervals in a circumferential direction of the stator core, the stator core also having a plurality of tooth portions each of which is formed to radially extend between one circumferentially-adjacent pair of the slots; and
a stator coil made up of a plurality of electric wires mounted on the stator core, each of the electric wires having a plurality of in-slot portions, each of which is received in one of the slots of the stator core, and a plurality of turn portions each of which is located outside of the slots of the stator core to connect one adjacent pair of the in-slot portions of the electric wire, and
the stator core has a plurality of displacement restricting portions each of which is formed, as an integral part of the stator core, on an axial end face of a corresponding one of the tooth portions of the stator core to restrict displacement of the stator coil relative to the stator core.
